(19) United States
(12) Patent Application Publication
(10) Pub. No.: US 2010/0327066 A1
(43) Pub. Date: Dec. 30, 2010

(54) NETWORK BASED RELIABLE DECODING OF BAR CODES

(75) Inventor: Farooq Khan, Allen, TX (US)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/816,646

(22) Filed: Jun. 16, 2010

Related U.S. Application Data
(60) Provisional application No. 61/269,474, filed on Jun. 25, 2009.

(51) Int. Cl. G06K 7/10; G06F 15/16; H04L 9/00

(52) U.S. Cl. 235/462.01; 709/219; 713/150

(57) ABSTRACT

An apparatus and method for network-based decoding of barcodes are provided. The method includes scanning, by a mobile device, a barcode; decoding, by the mobile device, data codewords encoded in the barcode; determining, by the mobile device, whether the data codewords contain errors; and when the data codewords contain errors, transmitting barcode information from the mobile device to a barcode server for decoding into the data codewords.

### CROSS-REFERENCE TO RELATED APPLICATIONS

This application claims the benefit under 35 U.S.C. §119(e) of a U.S. Provisional application filed on Jun. 25; 2009 in the U.S. Patent and Trademark Office and assigned Ser. No. 61/269,474, the entire disclosure of which is hereby incorporated by reference.

### BACKGROUND OF THE INVENTION

1. Field of the Invention

The present invention relates to an apparatus and method for barcodes. More particularly, the present invention relates to an apparatus and method for network based reliable decoding of barcodes.

2. Description of the Related Art

2D barcodes are fast gaining traction as enablers for online content and services. 2D barcodes storing addresses and URLs may appear in magazines, on signs, buses, business cards or just about any object that users might need information about. Users with a camera phone equipped with the correct reader software can scan the image of the 2D barcode causing the phone's browser to launch and redirect to the programmed URL. This act of linking from physical world objects is known as a hardlink or physical world hyperlinks. Users can also generate and print their own 2D barcodes for others to scan.

The current method used for 2D barcodes decoding results in a large error rate because decoding is performed locally in the barcode scanning and decoding device. In other cases, the image of the barcode is transmitted across a network to a remote location. The image is reproduced at the remote location and the barcode is scanned. This approach, however, requires transmitting large amount of data in the image file across the network. Moreover, this approach requires reproducing the image at the remote location.

Accordingly, there is a need for an apparatus and method for enhancing the error correction in barcodes scanned by a mobile device.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reliably decoding barcodes.

In accordance with an aspect of the present invention, a method for providing a user interface in a mobile terminal having a software mode and a hardware mode is provided. The method includes scanning, by a mobile device, a barcode; decoding, by the mobile device, data codewords encoded in the barcode; determining, by the mobile device, whether the data codewords contain errors; and when the data codewords contain errors, transmitting barcode information from the mobile device to a barcode server for decoding into the data codewords.

According to another aspect of the present invention, a method of decoding a barcode scanned by a mobile device is provided. The method includes receiving barcode information from a mobile device, and decoding data codewords based on the barcode information and supplementary information.

According to another aspect of the present invention, a mobile device is provided. The mobile device includes a wireless transceiver for communicating with a base station, a barcode scanning unit for scanning a barcode, a barcode decoding unit for decoding the barcode, for determining whether data codewords in the barcode contain errors, for transmitting barcode information about the barcode to a base station via the wireless transceiver, and for receiving corrected data codewords from the base station, and at least one application program stored in a storage unit, for reproducing content according to the corrected data codewords.

According to another aspect of the present invention, a barcode server is provided. The barcode server includes a communication unit for communicating with a mobile device, a barcode database for storing supplementary information on barcodes, and a barcode decoder for decoding and correcting data codewords received from the mobile device via the communication unit, wherein the barcode decoder decodes and corrects the data codewords based on the supplementary information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram of a two dimensional (2D) barcode according to an exemplary embodiment of the present invention;

FIG. 2 is a flowchart of an encoding procedure for a Quick Response (QR) barcode according to an exemplary embodiment of the present invention;

FIG. 3 illustrates a flowchart of a decoding operation for a 2D barcode, according to exemplary embodiments of the present invention;

FIG. 4 illustrates an error correction coding process according to an exemplary embodiment of the present invention;

FIG. 5 illustrates a network or server assisted 2D barcode decoding scheme according to an exemplary embodiment of the present invention;

FIG. 6 illustrates a flowchart showing 2D barcode decoding according to an exemplary embodiment of the present invention;

FIGS. 7A and 7B illustrate a mobile device and a barcode server, respectively, according to an exemplary embodiment of the present invention;

FIGS. 8A-8F illustrate interactions between a mobile device, a barcode server, and/or a content server, according to exemplary embodiments of the present invention;

FIG. 9 illustrates a method of network-based barcode decoding based on a barcode identifier according to an exemplary embodiment of the present invention; and

FIG. 10 shows barcode decrypting and decoding according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following exemplary embodiments of the present invention are described as applied to a “mobile device.” However, it is to be understood that this is merely a generic term and that the invention is equally applicable to any of a mobile phone, a palm sized Personal Computer (PC), a Personal Digital Assistant (PDA), a Hand-held PC (HPC), a smart phone, an International Mobile Telecommunication 2000 (IMT-2000) terminal, a wireless Local Area Network (LAN) terminal, and the like. Accordingly, use of the term “mobile terminal” should not be used to limit application of the present inventive concepts to any certain type of apparatus or device.

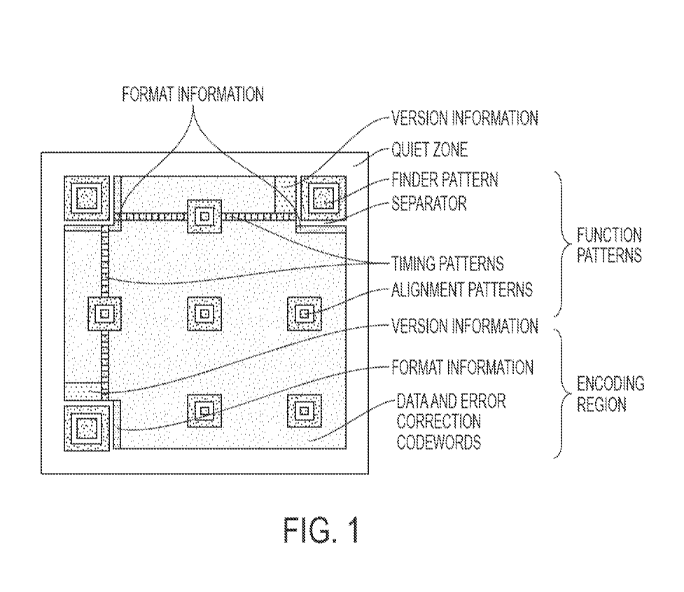

FIG. 1 is a diagram of a two dimensional (2D) barcode according to an exemplary embodiment of the present invention.

Referring to FIG. 1, 2D or two dimensional barcodes can contain more information than conventional one dimensional linear barcodes, such as a UPC code. As more data is encoded, a linear barcode becomes wider. The 2D barcodes make use of the vertical dimension to pack in more data without increasing the barcode width.

Several 2D barcode symbologies have been standardized by the International Organization for Standardization (ISO) and the International Electrotechnical Commission (IEC). The ISO/IEC 18004 standard specifies a 2D barcode symbology referred to as Quick Response (QR) code. Each QR Code symbol is constructed of nominally square modules set out in a regular square array and consists of an encoding region and function patterns, namely finder, separator, timing patterns, and alignment patterns. Function patterns do not encode data. The symbol is surrounded on all four sides by a quiet zone border. A structure of a Version 7 symbol of the QR code is shown in FIG. 1. There are forty sizes of QR Code 2005 symbol referred to as Version 1, Version 2, and so on, up to Version 40. Version 1 measures 21 modules ×21 modules, Version 2 measures 25 modules ×25 modules, and so on increasing in steps of 4 modules per side up to Version 40, which measures 177 modules ×177 modules. The data is encoded in 2×4 blocks with each block carrying 8-bits of data.

Other types of 2D barcodes are also in use. For example, a High Capacity Color Barcode (HCCB), also branded Microsoft Tag, is a type of barcode that uses colored triangles, instead of black-and-white lines or squares used by other barcode systems.

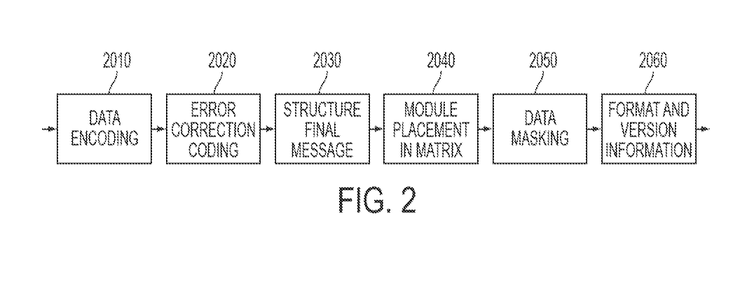

FIG. 2 is a flowchart of an encoding procedure for a QR barcode according to an exemplary embodiment of the present invention.

Referring to FIG. 2, in the data encoding stage, step 2010, data characters to be encoded are converted into a bit stream and the resulting bit stream split into 8-bit long codewords. The bit stream is typically made up of a mode indicator field, a character count indicator field, and the actual data bit stream. A mode is a method of representing a defined character set as a bit string. A four-bit mode identifier indicates the mode in which the following data sequence is encoded.

For example, assume the data to be encoded is ABΓΔE, the Extended Channel Interpretation (ECI) mode is 0111, the ECI assignment number is (000009) 00001001, and the mode indicator is 0100. Since the character count is 5, the character count indicator is set to (5) 00000101 with the data stream as:

ABΓΔE: 10100001 10100010 10100011 10100100 10100101

The final bit string is then given as:

0111 00001001 0100 00000101 10100001 10100010 10100011 10100100 10100101

Some form of coding is used in 2D barcodes to correct erasures and errors. An erasure is an unscanned or undecodable symbol character. An error is a misdecoded symbol character. Since most 2D barcodes use a matrix symbology, a defect converting a module from dark to light or vice versa will result in the affected symbol character misdecoding as an apparently valid but different codeword. Such an error causing a substitution error in the data may need two error or correction codewords to correct. The QR code employs Reed-Solomon (RS) error control coding to detect and correct errors. The bit stream is divided into codewords of 8 bits in length. A series of error correction codewords is generated. In the error correction coding stage, step 2020, the error correction codewords are added to the data codeword sequence in order to enable the symbol to withstand some damage without loss of data. Four user-selectable levels of error correction may be provided, which offer the capability of recovery from various amounts of damage.

In the third stage of structuring of final message, step 2030, the data codeword sequence is divided into n blocks according to the version and error correction level. For each data block, a corresponding block of error correction codewords is calculated, and the final sequence is assembled by taking data and error correction codewords from each block in turn.

In the fourth stage of module placement in matrix, step 2040, the codeword modules are placed in the matrix together with the finder pattern, separators, timing pattern, etc. The data is encoded in 2×4 regular blocks. Each block includes 8 bits of data.

In the data masking stage, step 2050, the data masking patterns are applied to the encoding region of the symbol. The data masking patterns are applied to the encoding region of the symbol such that dark and light modules are arranged in a well balanced manner in the symbol. In order to differentiate a quiet zone from an encoding region more effectively, more dark modules are placed at the edge of the symbol.

In the format and version information adding stage, step 2060, a 15-bit format information sequence containing 5 data bits, with 10 error correction bits calculated using the (15, 5) BCH code is mapped to the 2D symbol. The format information appears twice in the symbol in order to provide redundancy.

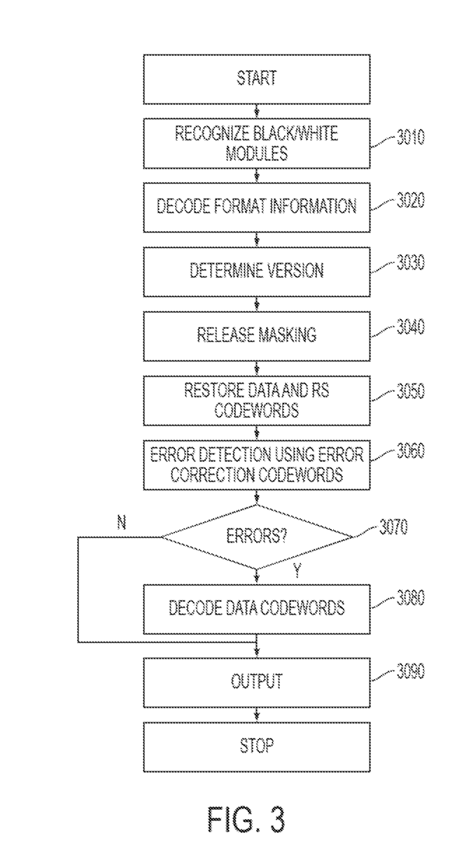

FIG. 3 illustrates a flowchart of a decoding operation for a 2D barcode, according to an exemplary embodiment of the present invention.

Referring to FIG. 3, the decoding steps from reading a 2D barcode symbol to outputting data characters are the reverse of the encoding procedure as shown in FIG. 2. Step 3010 includes locating and obtaining an image of the symbol, recognizing dark and light modules as an array of “0” and “1” bits, and identifying reflectance polarity from finder pattern module coloring.

In step 3020, the format information is read, the masking pattern is released and any necessary error correction on the format information modules is performed. If successful, the symbol is assumed to be in normal orientation; otherwise, mirror image decoding of format information is attempted. The error correction level is then identified, either directly in QR code symbols, or from micro QR code symbol numbers and a data mask pattern reference.

In step 3030, the version information (where applicable) is read and the version of the symbol (from the symbol number, in the case of Micro QR Code symbols) is determined. In step 3040, the data masking is released by XORing the encoding region bit pattern with the data mask pattern. The reference of the data mask pattern can be extracted from the format information. In step 3050, the symbol characters are read according to the placement rules for the model, and the data and error correction codewords of the message are restored. In step 3060, errors are detected using the error correction codewords corresponding to the level information. If errors are detected in step 3070, error correction decoding is performed in step 3080. If no errors are detected, or the errors are corrected, the data codewords are divided into segments according to the mode indicators and character count indicators. Finally, in step 3090, the data characters are decoded according to with the mode(s) in use and the result is output.

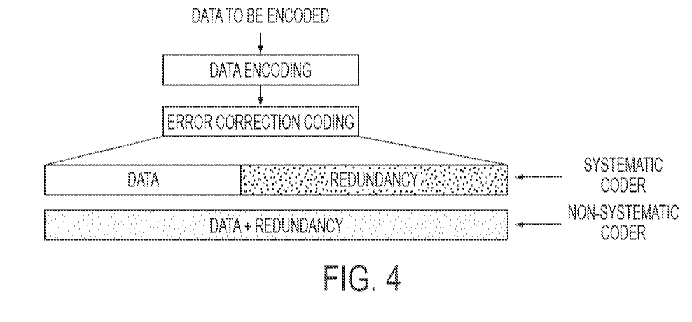

FIG. 4 illustrates an error correction coding process according to an exemplary embodiment of the present invention.

Referring to FIG. 4, some commonly used error correction schemes include Reed-Solomon (RS), BCH, convolutional, turbo, and Low-Density Parity Check (LDPC) codes. The data to be encoded is provided as input to an error correction coder (not shown). The output of the error correction coder is data and redundancy bits in the case of a systematic coder. In the case of a non-systematic coder, the data and redundancy bits at the output of the coder are mixed and data and redundancy bits cannot be easily separated. The current method used for 2D barcodes decoding results in a large error rate because decoding is performed locally in the barcode scanning and decoding device without any external help.

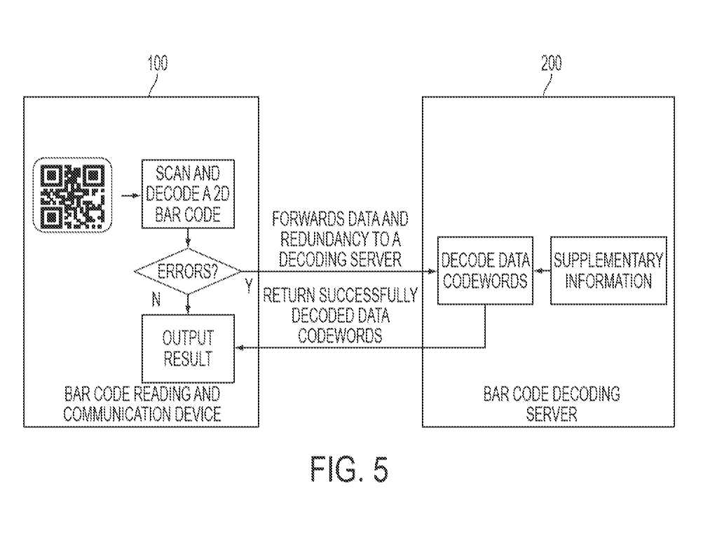

FIG. 5 illustrates a network or server assisted 2D barcode decoding scheme according to an exemplary embodiment of the present invention.

Referring to FIG. 5, a barcode reading and communication device, such as a mobile device 100, communicates with a barcode server 200 over the network. The barcode server 200 does not need to be dedicated hardware and can be implemented, on a cloud computing platform. The mobile device 100 is capable of scanning a 2D barcode and extracting coded data and redundancy bits. The barcode server is capable of decoding the data codewords from the received data and redundancy bits. When the mobile device 100 fails to successfully decode a 2D barcode, the mobile device 100 forwards the raw data and redundancy codewords to the barcode server 200. The barcode server 200 has access to supplementary information, such as a database of possible 2D barcodes. The barcode server 200 uses the supplementary information along with the raw data and redundancy codewords received from the mobile device 100 to decode the data codewords. The successfully decoded data codewords are then sent back to the mobile device 100.

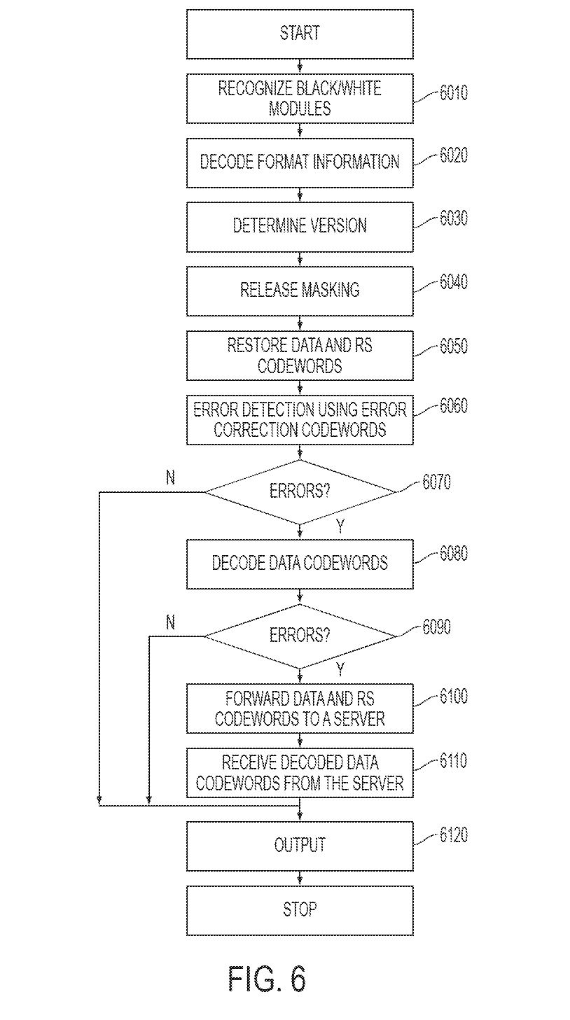

FIG. 6 illustrates a flow chart showing 2D barcode decoding according to an exemplary embodiment of the present invention.

Referring to FIG. 6, the 2D barcode decoding method is similar in many respects to the decoding method described above with respect to FIG. 3, and thus description of similar operations will be omitted herein for brevity. The difference compared to the decoding scheme illustrated in FIG. 3 is that the mobile device 100 forwards data and redundancy (RS) codewords to the barcode server 200 when the mobile device 100 fails to decode the barcode. In step 6090, the mobile device 100 determines whether errors are present in the decoded data. If errors are present, the mobile device forwards the raw data and the RS codewords to the barcode server 200 in step 6100. The mobile device 100 may forward other types of barcode data to the base station in addition to or instead of the raw data and RS codewords. Some examples of additional barcode data are described below. The barcode server corrects the errors based on the received raw data and RS codewords. In step 6110, the mobile device 100 receives the corrected data codewords from the barcode server 100.

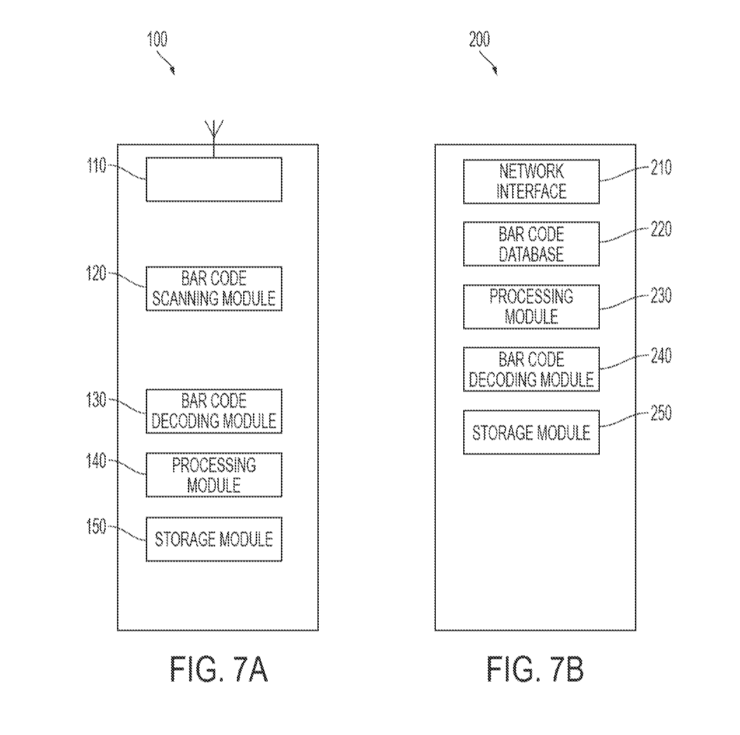

FIGS. 7A and 7B illustrate a mobile device and barcode server, respectively, according to an exemplary embodiment of the present invention.

Referring to FIG. 7A, the mobile device 100 includes a wireless communication module 110, a barcode scanning module 120, a barcode decoding module 130, a processing module 140, and a storage module 150. The mobile device 100 may also include other components not illustrated, including a power module to supply power (either from a battery or an external power source), input/output modules to interact with the user, and the like. Similarly, the functionality of two or more modules may be integrated into a single component. The mobile device 100 may also include one or more services requiring access to online information or content. These services may take the form of applications stored in the storage module 150 and executed by the processing module 140.

The barcode scanning module 120 and the barcode decoding module 130 scans and decodes, respectively, a barcode. The barcode scanning module 120 scans the barcode, recognizes the black and white modules contained within the barcode, and then passes this information to the barcode decoding module 130. The barcode decoding module 130 decodes the data contained in the scanned barcode. If the barcode decoding module 130 detects errors in the decoded data, the barcode decoding module 130 passes the information to the wireless communication module 110. The wireless communication module 110 provides wireless communication allowing the mobile device 100 to communicate with the barcode server 200. The wireless transceiver transmits information on the scanned barcode to the barcode server 200, and receives the resulting decoded/corrected data codewords from the barcode server 200. The data codewords received from the barcode server 200 is provided to the barcode decoding module 130, which performs any additional processing and outputs the decoded data codewords. As mentioned above, the barcode decoding module may provide the data codewords to an application running on the mobile device 100. Examples of how the codewords may be used by the mobile device 100 are described below.

According to exemplary embodiments of the present invention, the bar mobile device 100 may contact the barcode server 200 only when the barcode decoding module 130 is unable to decode the barcode. If the barcode decoding module 130 is able to decode the barcode successfully, the decoding module 130 can output the decoded codewords and enable the mobile device 100 to access content linked through the barcode without assistance from the barcode server 200.

Referring to FIG. 7B, the barcode server 200 includes a network interface 210, a barcode database 220, a processing module 230, a barcode decoding module 240, and a storage module 250. The barcode database 220 includes barcodes and other supplementary information that can be used to assist in decoding the barcode scanned by the mobile device 100. According to other exemplary embodiments of the present invention, the barcode database 220 may be provided separately from the barcode server 200. The barcode server 200 may also include other components not shown such as a power module to supply power.

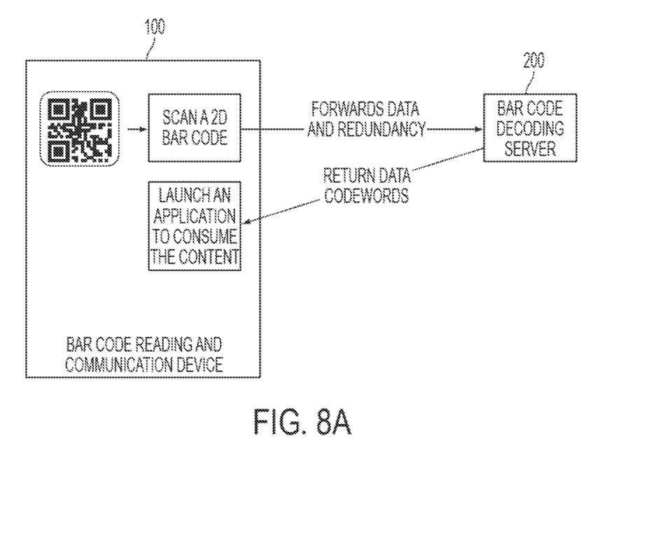

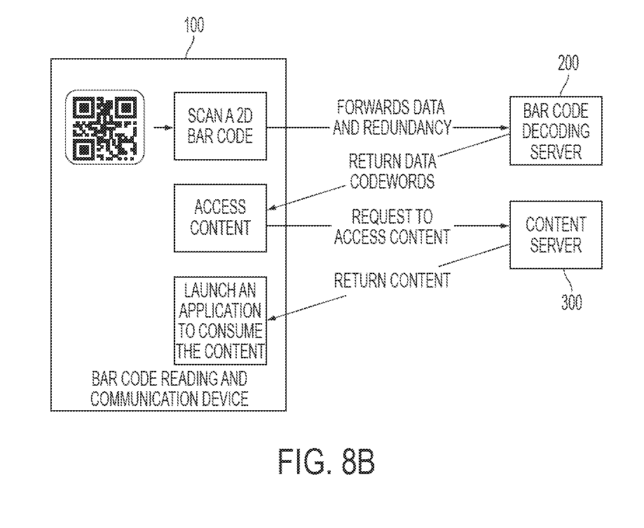

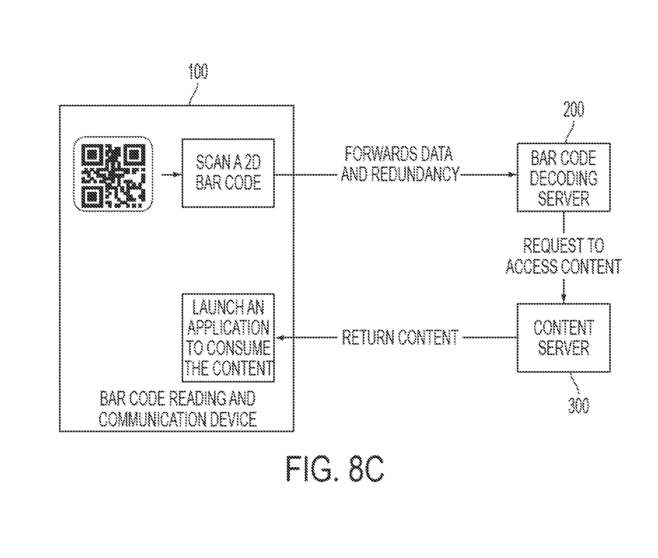

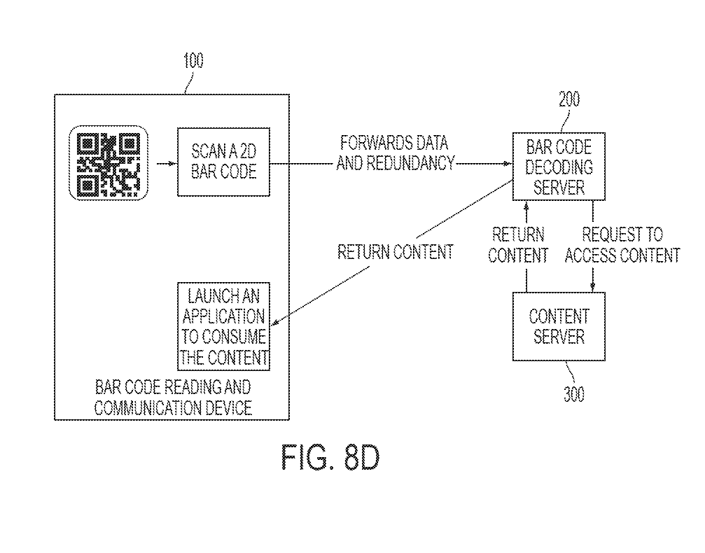

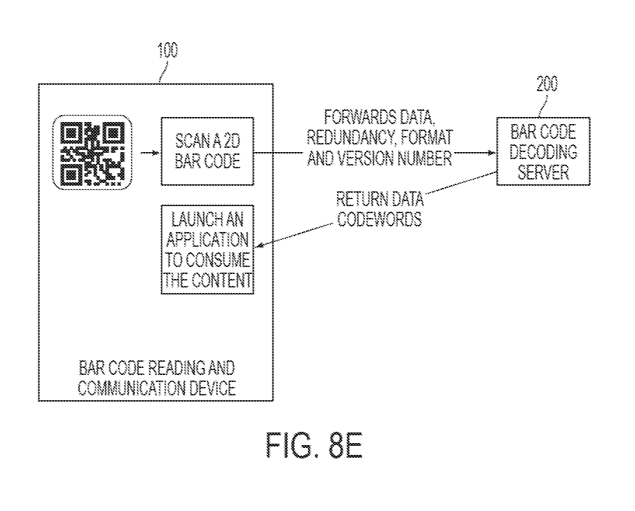

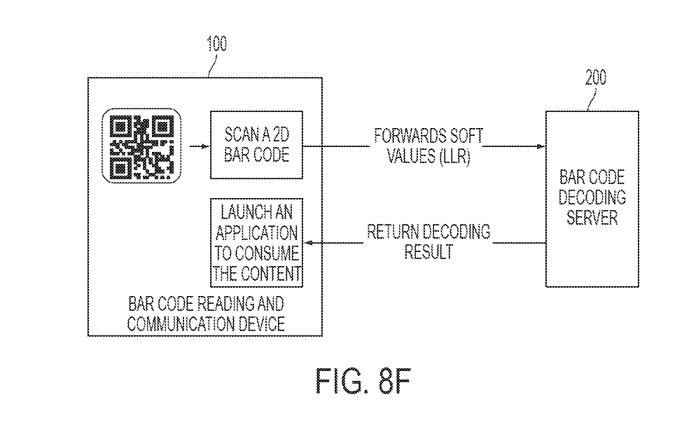

The network interface 210 allows the barcode server 200 to communicate with other entities, such as the mobile device 100 and content servers 300 (not shown). The network interface 210 receives barcode data from the mobile device 100 and provides the barcode data to the 2D barcode decoding module 240. The 2D barcode decoding module decodes the barcode data based on supplementary information, which may be contained in the 2D barcode database 220. The barcode data may include the raw data and RS codewords discussed above, or may include additional information as discussed below. The decoded data codewords are then provided to the mobile device 100. This operation is merely an example of the interaction between the mobile device 100 and the barcode server 200. Additional exemplary interactions are described below with respect to FIGS. 8A-8F.

FIGS. 8A-8F illustrate interactions between the mobile device 100, the barcode server 200, and/or the content server 300, according to exemplary embodiments of the present invention.

Referring to FIG. 8A, the mobile device 100 forwards the raw data and redundancy codewords obtained from scanning a 2D barcode to the barcode server 200. The barcode server 200 decodes the data codewords and returns the result to the barcode reading and communication device. The mobile device 100 then launches an application related to the decoded data codewords. For example, when the mobile device 100 scans a barcode containing a business card, the mobile device 100 forwards the raw data and redundancy codewords to the barcode server 200 and receives the data codewords from the barcode server 200, the mobile device 100 launches an application to store the business card information in an address book.

Referring to FIG. 8B, the mobile device 100 forwards raw data and redundancy codewords obtained from scanning a 2D barcode to the barcode server 200. The barcode server 200 decodes the barcode and returns the data codewords to the mobile device 100. The mobile device 100 then sends a request to access content to the content server 300 according to information contained in the data codewords. The content server returns the appropriate content, and the mobile device 100 launches an application according to the received content. For example, when the mobile device scans a barcode containing a URL, the mobile device 200 launches an application such as a web browser to access the content linked via the URL.

Referring to FIG. 8C, after decoding the barcode received from the mobile device 100, the barcode server 200 sends a request to access content to the content server 399 on behalf of the mobile device 100. The barcode server 200 determines whether to contact the content server 300 based on the result of the barcode decoding operation. The barcode server 200 may also take into account a structure of the network, capabilities of the mobile device 100, or preferences set by the mobile device 100. The content server 300 then returns the requested content directly to the mobile device 100. The mobile device 100 may then launch an appropriate application based on the received content

Referring to FIG. 8D, after decoding the barcode received from the mobile device 100, the barcode server 200 sends a request to access content to the content server 300 on behalf of the mobile device 100. The barcode server 200 makes this decision based on the result of the barcode decoding operation. The content server then returns the requested content back to the barcode server 200. The barcode server 200 forwards the received content to the mobile device 100. The exemplary embodiment shown in FIG. 8D differs from that shown in FIG. 8C in that the barcode server 200 acts as an intermediary or gateway between the mobile device 100 and the content server 300.

Referring to FIG. 8E, the mobile device 100 may also transmit additional information to the barcode server 200. The additional information may include Format and Version information in the case of a QR code. In some cases, the mobile device 100 is unable to decode the data codewords in the barcode, but is able to decode the Format and Version number, due to stronger protection on this field. In the QR code, the format and version information adds a 15-bit format information sequence containing 5 data bits, with 10 error correction bits calculated using the (15, 5) BCH code. The format information appears twice in the symbol in order to provide redundancy. This Format and Version number is then used by the barcode server 200 to decode the data codewords. In cases where the mobile device 100 is unable to decode the Format and Version information, the coded bits are forwarded to the barcode server 200. The barcode server 200 can then make use of additional information available to it, such as possible set of format and version information, to first decode Format and version information and then decode the data codewords. The barcode server 200 then either transmits the decoded data codewords to the mobile device 100 or requests content from the content server 300, as discussed in some of the previous exemplary embodiments.

Referring to FIG. 8F, the barcode is encoded using advanced coding, such as a Turbo code or a low-density parity-check code (LDPC). The mobile device 100 forwards soft values, such as Log-Likelihood Ratios (LLR), to the barcode server 200. In this case, the LLR should be quantized using, for example, 8-bits per data/parity sample. The barcode server 200 performs a soft-decision decoding using, for example, iterative decoding principles, to decode the data codewords. The barcode server 200 then either returns the decoding result to the mobile device 100 or transmits a request to the content server 300, as discussed in some of the previous exemplary embodiments.

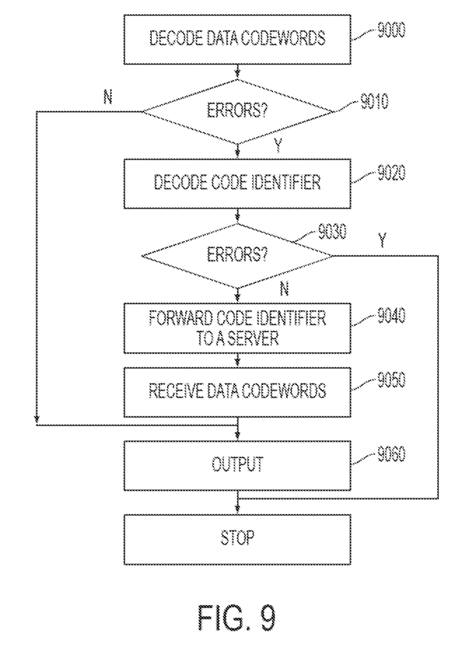

FIG. 9 illustrates a method of network-based barcode decoding based on a barcode identifier, according to an exemplary embodiment of the present invention. In FIG. 9, decoding operations similar to those described in FIG. 6 are omitted for clarity.

Referring to FIG. 9, a barcode identifier field with more robust coding is added to the barcode. The barcode identifier can be repeated in the barcode symbol at several disjoint positions for redundancy. With a more robust coding and mapping to the barcode symbol, the likelihood of successful decoding is higher for the barcode identifier than the data codeword. A barcode identifier, for example, can be a 16-bit field allowing 65536 different identifiers. The barcode server keeps a database specifying a mapping from the barcode identifier to the actual data codewords. With this arrangement, when the mobile device 100 decodes the barcode identifier but is unable to decode the data codewords, the mobile device 100 can forward the barcode identifier to the barcode server 200. The barcode server 200 then maps the received barcode identifier to the data codewords, decodes the data codewords, and returns the data codewords to the mobile device 100.

In step 9000, the mobile device decodes the data codewords in a scanned barcode. The mobile device detects any errors in the codewords in step 9010. If no errors are detected, the data codewords are output. Otherwise, the mobile device 100 decodes the barcode identifier in step 9020, and determines whether the barcode identifier contains errors in step 9030. If the barcode identifier does not contain any errors, the mobile device 100 transmits the barcode identifier to the barcode server in step 9040. In step 9050, the mobile device 100 receives the data codewords from the barcode server, and outputs the data codewords according to a scheme such as those described above with respect to FIGS. 8A-8F.

According to the method of FIG. 9, when the mobile device 100 fails to decode the data codeword, the mobile device forwards the coded bits for the identifier to the barcode server. With this arrangement, when the mobile device 100 is unable to decode the data codewords and the barcode identifier, the barcode server 200 can decode the barcode identifier, map the identifier to the data codewords and return the data codewords to the mobile device 100.

The barcode server 200 may use any the decoding methods when decoding data codewords, barcode identifiers, and/or format and version information, such as maximum-likelihood decoding. With knowledge of possible codewords, barcode identifiers, and/or format and version information, the barcode server 200 can greatly improve the decoding performance. In contrast, the mobile device 100 may have no knowledge about the possible set of codewords, barcode identifiers, and/or format and version information. For example, the barcode server 200 may store data codewords in a database and refer to the stored data codewords as supplementary information when decoding the received raw data.

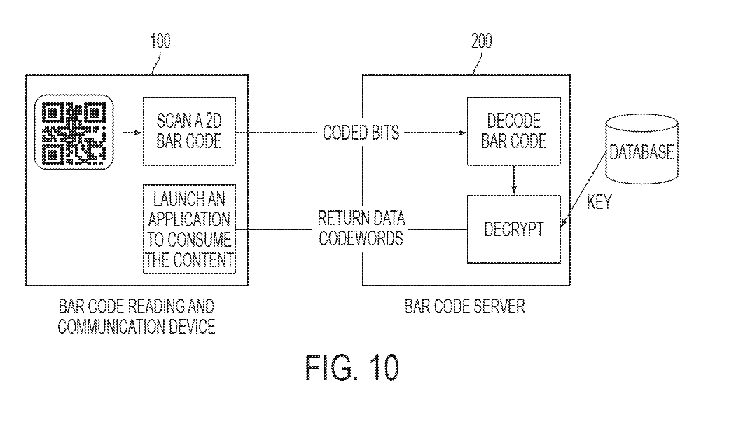

FIG. 10 shows barcode decrypting and decoding according to an exemplary embodiment of the present invention.

Referring to FIG. 10, the barcode server 200 decodes and decrypts the barcode information and return the decrypted data codewords to the mobile device 100. The information encoded in the barcode can be encrypted to provide a security function so that only legitimate barcodes are decoded by the users. The barcode server can consult a database to obtain the decryption key. The information encoded in the barcode can be encrypted either before error correction coding. Referring back to FIG. 2, the information in the barcode can be decrypted prior to step 2020 (error correction coding), or the error-corrected data can be encrypted after step 2020. The barcode server can perform error correction decoding before or after the decryption operation, depending on the stage in which the encryption took place.

The exemplary embodiments described above have assumed 2D barcodes. However, exemplary embodiments of the present invention may also employ linear (1D) barcodes as well as other methods of physical representation of identification keys, such as a Radio Frequency Identification (RFID) tag or a Near Field Communication (NFC) tag.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for decoding a barcode, the method comprising:
scanning, by a mobile device, a barcode;
decoding, by the mobile device, data codewords encoded in the barcode;
determining, by the mobile device, whether the data codewords contain errors; and
when the data codewords contain errors, transmitting barcode information from the mobile device to a barcode server for decoding into the data codewords.

2. The method of claim 1, further comprising:
receiving corrected data codewords from the barcode server; and
accessing content based on the corrected data codewords.

3. The method of claim 1, further comprising:
receiving corrected data codewords from the barcode server;
accessing a content server identified in the corrected data codewords; and
receiving content identified in the corrected data codewords from the content server.

4. The method of claim 1, further comprising:
receiving content identified in the data codewords transmitted to the barcode server.

5. The method of claim 4, wherein the content is received from the barcode server.

6. The method of claim 4, wherein the content is received from a content server identified in the data codewords.

7. The method of claim 1, wherein the barcode information comprises raw data and redundancy information.

8. The method of claim 7, wherein the barcode information further comprises format and version information.

9. The method of claim 1, wherein the barcode information comprises soft values related to the data codewords.

10. The method of claim 1, wherein the barcode information comprises a barcode identifier.

11. The method of claim 1, wherein the barcode information is encrypted.

12. A method of decoding a barcode scanned by a mobile device, the method comprising:
receiving barcode information from a mobile device; and
decoding data codewords based on the barcode information and supplementary information.

13. The method of claim 12, further comprising:
transmitting the data codewords to the mobile device.

14. The method of claim 12, further comprising:
transmitting a request for content to a content server, based on information contained in the data codewords.

15. The method of claim 14, further comprising:
receiving the content from the content server; and
transmitting the content to the mobile device.

16. The method of claim 12, wherein the barcode information includes raw data, redundancy information, and format and version information, and
wherein the decoding of the data codewords comprises decoding the data codewords based on the supplementary information, the redundancy information, and the format and version information.

17. The method of claim 12, wherein the barcode information includes soft values, and
wherein the decoding of the data codewords comprises decoding the data codewords based on the supplementary information and the soft values.

18. The method of claim 12, wherein the barcode information comprises a barcode identifier, and the method further comprises:
mapping the barcode identifier to the data codewords,
wherein the decoding of the data codewords comprises decoding the data codewords based on the mapped barcode identifier.

19. The method of claim 12, wherein the data codewords are encrypted, and the method further comprises:
decrypting the encrypted data codewords.

20. A mobile device comprising:
a wireless transceiver for communicating with a base station;
a barcode scanning unit for scanning a barcode;
a barcode decoding unit for decoding the barcode, for determining whether data codewords in the barcode contain errors, for transmitting barcode information about the barcode to a base station via the wireless transceiver, and for receiving corrected data codewords from the base station; and
at least one application program stored in a storage unit, for reproducing content according to the corrected data codewords.

21. The mobile device of claim 20, wherein the at least one application program requests a content server for the content, the content server being identified in the corrected data codewords.

22. The mobile device of claim 20, wherein the mobile device receives the content from the barcode server.

23. The mobile device of claim 20, wherein the barcode information comprises redundancy information and format and version information.

24. The mobile device of claim 20, wherein the barcode information comprises a barcode identifier contained in the barcode.

25. The mobile device of claim 20, wherein the data codewords are encrypted, and the mobile device receives decrypted corrected data codewords from the barcode server.

26. A barcode server comprising:
a communication unit for communicating with a mobile device;
a barcode database for storing supplementary information on barcodes; and
a barcode decoder for decoding and correcting data codewords received from the mobile device via the communication unit,
wherein the barcode decoder decodes and corrects the data codewords based on the supplementary information.

27. The barcode server of claim 26, wherein the barcode decoder transmits the corrected data codewords to the mobile device via the communication unit.

28. The barcode server of claim 26, wherein the barcode server transmits a request for content to a content server based on information contained in the corrected data codewords.

29. The barcode server of claim 28, wherein the request includes an address of the mobile device so as to permit the content server to transmit the requested content to the mobile device.

30. The barcode server of claim 28, wherein the communication unit receives the content from the content server and transmits the content to the mobile device.

31. The barcode server of claim 26, wherein the barcode server receives redundancy information and format and version information from the mobile device, and the barcode decoder decodes and corrects the data codewords based on the supplementary information, the redundancy information, and the format and version information.

32. The barcode server of claim 26, further comprising:
a decryption module for decrypting encrypted data codewords received from the mobile device and for providing the decrypted data codewords to the barcode decoder.

33. The barcode server of claim 26, wherein the barcode decoder decodes the data codewords with reference to a barcode identifier received from the mobile device.

34. The barcode server of claim 26, wherein the barcode decoder receives soft values from the mobile device and decodes and corrects the data codewords according to the soft values.
